(19) United States
(12) Patent Application Publication
(10) Pub. No.: US 2007/0145945 A1
(43) Pub. Date: Jun. 28, 2007

(54) Method and apparatus to authenticate battery charging device

(76) Inventors: James W. McGinley, Barrington, IL (US); Donald Rimdzius, Addison, IL (US)

Correspondence Address: SEYFARTH SHAW LLP, 131 S. DEARBORN ST., SUITE2400, CHICAGO, IL, 60603-5803, US

(21) Appl. No.: 11/320,090

(22) Filed: Dec. 28, 2005

(51) Int. Cl. H02J 7/00

(52) U.S. Cl. 320/114

(57) ABSTRACT

A method and system for validating whether a battery charging device is authorized to charge a battery. An identifier from the battery charging device is received. It is evaluated whether the identifier meets at least one predetermined criteria. The battery charging device is allowed to charge the battery if the identifier meets the at least one predetermined criteria.

### FIELD

The present application relates to battery charging devices, and more particularly to battery charging devices for portable electronic devices.

### BACKGROUND

Portable electronic devices are generally powered by rechargeable batteries. When the batteries become depleted, the user must recharge the battery. This involves connecting a battery charger to the portable electronic device and attaching the charger to a wall outlet. After a period of time, the user can disconnect the charger and resume using the portable device.

Typically, when a user purchases a portable electronic device, the charger comes with it. Nevertheless, for a number of reasons, i.e. loss, theft, flexibility of use, the user can purchase an extra charger, either from the manufacturer or a third party. Quite often third party chargers are of unknown quality and it is possible they could do damage to the portable electronic devices which they are designed to charge, or it is possible the third party chargers are not TUV or UL approved. Accordingly, what is needed is a method and system in which the portable electronic device can authenticate, or validate, a charger before enabling it to charge a battery.

### SUMMARY OF THE INVENTION

In one embodiment, a method for validating whether a battery charging device is authorized to charge a battery is provided. An identifier from the battery charging device is received. It is evaluated whether the identifier meets at least one predetermined criteria. The battery charging device is allowed to charge the battery if the identifier meets the at least one predetermined criteria.

In other embodiments, the identifier is a code received from the battery charging device. The code is compared to a preexisting code. The battery charging device is allowed to charge the battery if the code from the battery charging device matches the preexisting code. The code is representative of a manufacturer of the battery charging device.

In additional embodiments, the battery charging device is prevented from charging the battery if the identifier does not meet the at least one predetermined criteria. The identifier is received over a single conductor interface connected to the battery charging device, a multiple conductor interface connected to the battery charging device, or a wireless interface connected to the battery charging device. The identifier can also be received over the conductors that carry a charging current from the battery charging device. The identifier is received from the battery charging device by reading an encoded signal from the battery charging device and extracting the identifier from encoded signal.

In a further embodiment, an article for validating whether a battery charging device is authorized to charge a battery is provided. The article includes a computer-readable signal-bearing medium. Logic in the medium receives battery charging device. Logic in the medium evaluates whether the identifier meets at least one predetermined criteria. Logic in the medium allows the battery charging device to charge the battery if the identifier meets the at least one predetermined criteria.

In other embodiments, the article includes: Logic in the medium to receive a code from the battery charging device; logic in the medium to compare the code from the battery charging device to a preexisting code; logic in the medium to allow the battery charging device to charge the battery if the code from the battery charging device matches the preexisting code; logic in the medium to prevent the battery charging device from charging the battery if the identifier does not meet the at least one predetermined criteria; logic in the medium to receive the identifier over a single conductor interface connected to the battery charging device; logic in the medium to receive the identifier over a multiple conductor interface connected to the battery charging device; logic in the medium to receive the code over conductors that also carry a charging current from the battery charging device; logic in the medium to receive the identifier over a wireless interface from the battery charging device; logic in the medium to receive an encoded signal from the battery charging device and logic in the medium to decode the encoded signal such that the identifier is extracted.

In another embodiment, a system is provided. The system includes a battery charging device with circuitry that stores an identification code; a battery powered host device with a battery, an authorization code store, and battery control circuitry that allows the battery charging device to charge the battery if the identification code matches a preexisting code stored in the authorization code store. At least one interface connects the battery powered host device to the charging device. In other embodiments, the circuitry that stores the identification code is a read only memory (ROM). The identification code represents the manufacturer of the battery charging device. The authorization code store comprises read only memory embedded in the battery control circuitry. The interface includes a power interface that transmits a charging current from the battery charging device to the battery powered host device and a data interface that transmits code data between the battery powered host device and the battery charging device. The data interface can be a one conductor interface, a multiple conductor interface, or a wireless interface. The battery control circuitry comprises circuitry for reading data from the authorization control store and extracting the identification code from the data.

In another embodiment, a battery charger is provided. The battery charger includes an alternating current (AC) to direct current (DC) power supply or alternately, a direct current (DC) to direct current (DC) power supply. An authorization code store contains an identifier for the battery charger. At least one interface connect the battery charger to a battery powered host device.

In other embodiments, the at least one interface is a power supply interface to provide a charging current to the battery powered host device and a data interface to exchange code data with the battery powered host device. The authorization code store comprises a read only memory (ROM).

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

For the purpose of facilitating an understanding of the invention, there is illustrated in the accompanying drawings an embodiment thereof, from an inspection of which, when considered in connection with the following description, the invention, its construction and operation, and many of its advantages should be readily understood and appreciated.

FIG. 1 is a functional block diagram depicting one example of system including a battery powered host device and battery charging device in which the battery charging device is validated prior to charging.

FIG. 2 is an alternate embodiment in which the interface used to carry a charging current is employed to validate the battery charging device.

FIG. 3 is a flow chart depicting exemplary operation of the system of FIGS. 1 and 2.

### DETAILED DESCRIPTION

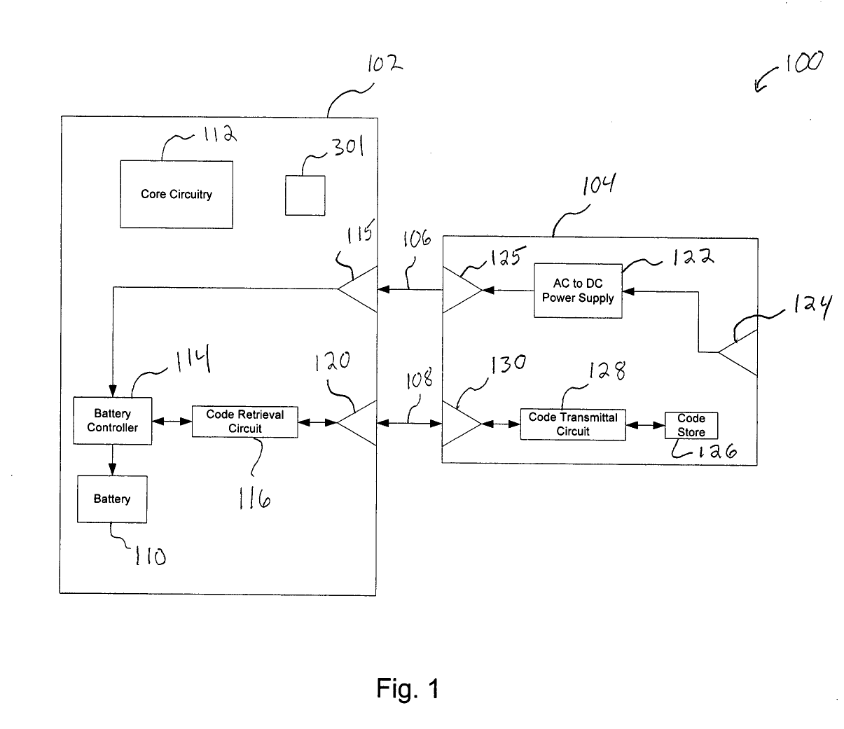

Referring to FIG. 1, a system 100 in one example comprises a battery powered host device 102 and a battery charging device 104. The battery powered host device 102 and the battery charging device 104 are connected by a charging interface 106 and an authentication interface 108.

The battery powered host device 102 is a device that is powered by a rechargeable battery 110. In one example, battery powered host device 102 is a battery powered electronic device. For example, battery powered host device 102 could be a mobile communications device, such as a mobile phone, a personal digital assistant (PDA), a mobile email terminal (e.g. a Blackberry®), a portable digital video recorder, a DVD, a navigation device, a satellite radio, a game device, a portable computer, or a combination of these devices. These example are provided for illustrative purposes only. It should be understood that the particular device could be any device powered by a rechargeable battery.

The battery powered host device 102 in one example comprises, in addition to battery 110, core circuitry 112, battery controller 114, port 115, code retrieval circuit 116, and port 120.

Core circuitry 112 in one example comprises hardware and/or software components that contribute to the core functioning of battery powered host device 102. For example, if battery powered host device 102 is a mobile phone, then core circuitry 112 will include the components necessary to render battery powered host device 102 as an operable mobile phone.

Battery controller 114 in one example controls the charging of battery 110. For instance, battery controller 114 might perform functions such as controlling the magnitude and/or duration of the current that is used to charge battery 110, monitoring the charge on the battery to prevent overcharging, monitoring the condition of the battery to determine when a new battery is needed, etc. Battery controller 114 in another example determines whether an identifier received from battery charging device 104 meets a predetermined criteria. In one example, the identifier received from battery charging device is a code, and the predetermined criteria is that the code must match a preexisting code embedded in memory of the battery powered host device 102. In another example, the identifier provides an indication of the make of the battery charger, and the predetermined criteria is that the particular make of battery charger is identified in memory of host device 102 as authorized to charge the battery. In another example, the identifier is the type of host device to be charged or the name of the manufacturer of the host device. These examples are provided for illustrative purposes only. It should be understood that other identifiers and predetermined criteria could be used depending on the needs of the manufacturers and consumers.

Battery controller 114 is connected to port 115, which is connected to charging interface 106. Accordingly, battery controller 114 enables charging device 104 to charge battery 110 if charging device 104 is validated, and battery controller 114 disables charging device 104 from charging battery 110 if charging device is not validated.

Code retrieval circuit 116 receives transmissions from authentication interface 108 through port 120. The identifier sent from charging device 104 is embedded in the transmissions. Code retrieval circuit 116 receives a transmission over interface 108 and decodes the transmission such that battery controller 114 can recognize it. Battery controller 114 then extracts the identifier from the transmission and compares it to a pre-existing identifier stored in memory (not shown) of the host device 102. For example, an identification code may be provided that rotates or is evolutionary in its cryptography.

Battery charging device 104 in one example comprises a battery charger. Exemplary battery charging devices are described in co-pending U.S. patent application entitled Plug with Supplemental Memory filed Dec. 15, 2005, and application Ser. No. 11/149,118 filed on Jun. 8, 2005, entitled “Compact Contour Electrical Converter Package,” which are hereby incorporated by reference. Battery charging device 104 includes an AC to DC power supply 122 or a DC to DC power supply or a DC to AC power supply, which is connected to port 124. Port 124 is operable to connect to an AC power supply or a DC power supply. For example, port 124 in one example can connect to a 120/240 VAC wall outlet or a 12 volt DC car outlet or other source such as a computer outlet. In an alternate embodiment, a USB or other connector style featuring a power source may have a code retrieval or transmission circuit. In the AC to DC power supply embodiment 122 converts an AC signal to a DC signal and supplies the DC signal to port 125. Port 125 is connected to battery powered host device 102 over interface 106.

Battery charging device 104 also includes circuitry to implement the authentication process describe herein. Battery charging device 104 includes a code store 126, a code transmittal circuit 128, and port 130. Code store 126 stores an identifier that is used by host device 102 to validate charging device 104. The identifier can take many forms depending on the needs of manufacturer or end user. For example, the identifier could represent the manufacturer of the charging device 104. In another example, the identifier could represent the owner of the charging device. In a further example, the identified could represent a version or type of the charging device or the power output of the charging device. The identifier could be a digital or alphanumeric code or take on a different form. For example, the identifier could be an analog signal such as a voltage or frequency level or timing code. In a further alternate embodiment the identifier might be a variable event sequence during a predetermined period. For example, the host device might send a low voltage level during a predetermined period such as the firs second of connection with the charging device 104 and the charger 104 may be programmed to respond to the low voltage level with pre-designated signal, such as a high voltage level within 1 second of receipt of the signal from the host device, which acts as a hand-shake in order to signal to the host device that the charger device 104 is authentic and okay to receive a charge from.

Code store 126 in one example comprises a logic component sufficient to store the code. For example, the code store 126 could be implemented as a read only memory (ROM), such as an EEPROM, or a simple electronic device, such as a flip flop.

Code transmittal circuit 128 is operable to retrieve the identifier from the code store 126 and encode it for transmission over interface 128. Code transmittal circuit 128 sends the transmission over interface 108 through port 130.

Power interface 106 in one example comprises a typical power interface used to charge electronic devices. For example, interface 106 could comprise a two wire power connection or multi-wire connection.

Authentication interface 108 in one example comprises an interface sufficient to transmit data from charger device 104 to host device 102. Interface could include a single conductor or multiple conductors. Interface 108 could be a wired interface or a wireless interface. Examples of interface 108 are the Universal Serial Bus (USB) interface, a serial interface, a Bluetooth® interface or RFID interface. The exact configuration of code retrieval circuit 116 and code transmittal circuit 128 will depend on the nature of interface 108. For instance, if interface 108 is a USB interface, code transmittal circuit 128 will be circuitry operable to format the code for transmission over a USB interface and code retrieval circuit 116 will be circuitry operable to decode the transmission from USB.

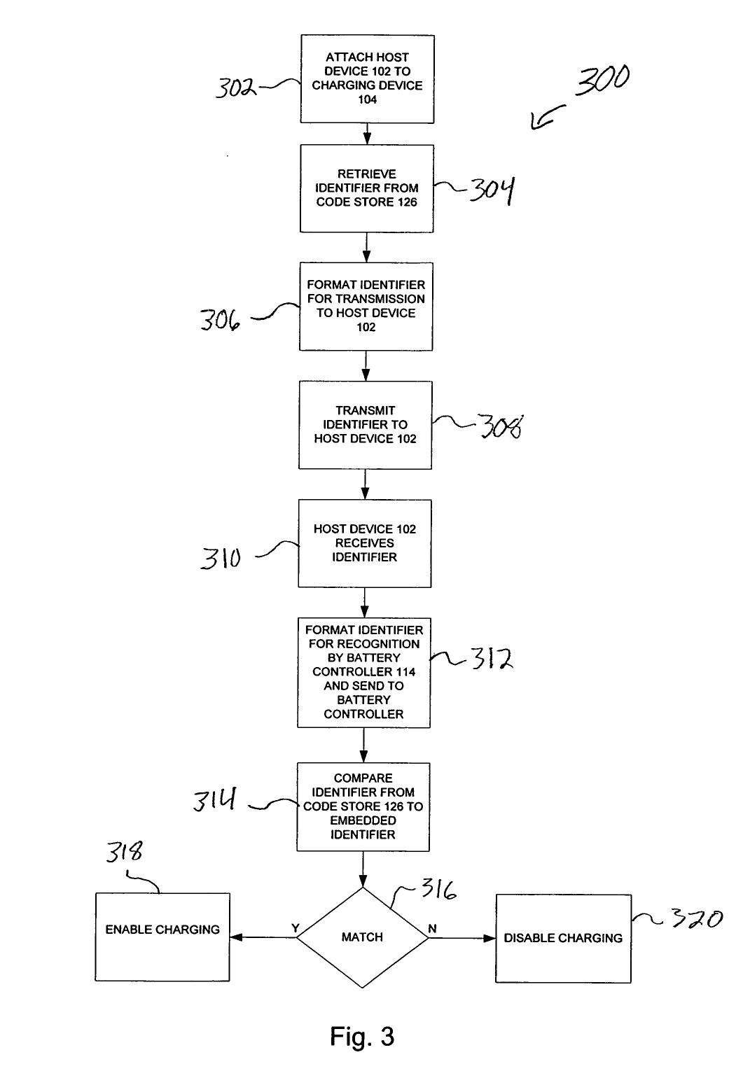

FIG. 3 depicts a process 300 by which host device 102 utilizes the identifier transmitted from charging device 104 to validate whether charging device 104 is authorized to charge battery 110 of host device 102. The process 300 in one example is performed by battery controller 114. In another example, process 300 is performed by core circuitry 112. In another example, process 300 is performed by a combination of core circuitry 112 and battery controller 114.

Referring further to FIG. 1, the process 300 is implemented by one or more logic components, such as computer software and/or hardware components, that carry out the process 300. A number of such components can be combined or divided. An exemplary component employs and/or comprises a series of computer instructions written in or implemented with any of a number of programming languages, as will be appreciated by those skilled in the art.

Referring further to FIG. 1, in one example, the process 300 is embedded in an article 301 including at least one computer-readable signal-bearing medium. One example of a computer-readable signal-bearing medium is a recordable data storage medium such as a magnetic, optical, and/or atomic scale data storage medium. In another example, a computer-readable signal-bearing medium is a modulated carrier signal transmitted over a network comprising or coupled with computing device or system, for instance, a telephone network, a local area network (“LAN”), the Internet, and/or a wireless network.

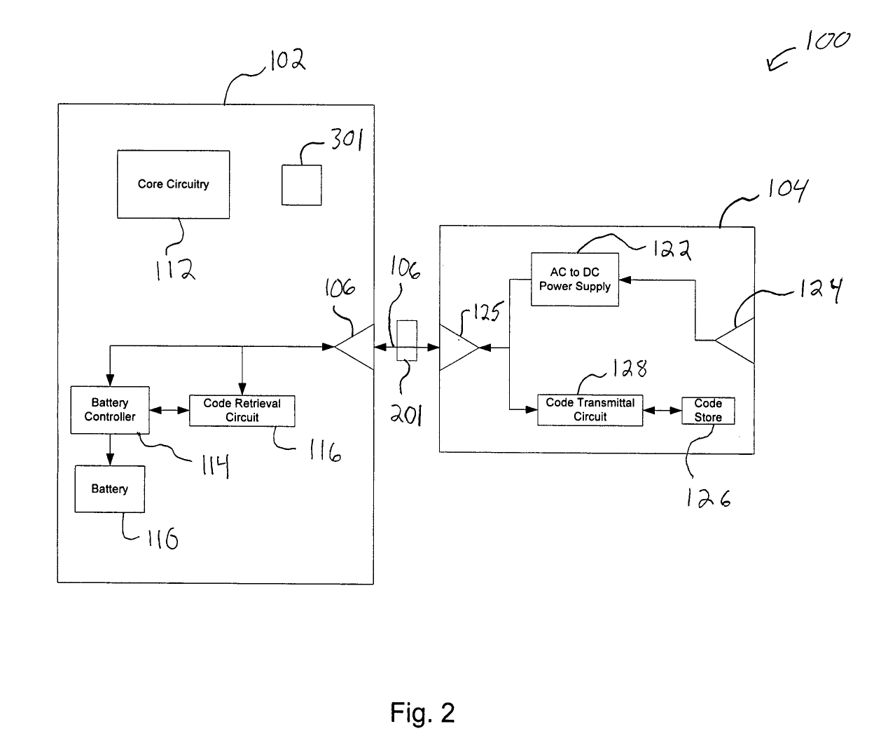

Referring to FIG. 2, an alternative embodiment of system 100 is shown. In this embodiment, there is no authentication interface 108. Instead, code transmittal circuit 128 of charging device 104 and code retrieval circuit 116 of host device 102 are connected through power interface 106. Code transmittal circuit 128 formats the identifier that is read from the code store 126 and superimposes the identifier on the charging current signal transmitted over the conductors of interface 106. For example, amplitude of frequency modulation may be used. In another embodiment, Time multi-plexing may provide for changing functioning of wires to be us signals during certain periods and transmitting current during other periods. The encoded superimposed identifier is shown as item number 201 in FIG. 2. Code retrieval circuit 116 receives the encoded superimposed identifier 201 and decodes it such that battery controller 114 can recognize the identifier provided therein. Battery controller 114 then validates whether charging device 104 is authorized to charge battery 110.

Referring to FIG. 3, exemplary operation of system 100 will now be provided for illustrative purposes. In step 302, the user attaches host device 102 to charging device 104 through power interface 106 and authentication interface 108. Alternatively, in the embodiment shown in FIG. 2, the host device 102 is only attached through power interface 106. In step 304, host device 102 initiates retrieval of the identifier from code store 126 of charging device 104. Battery controller 114, core circuitry, or some combination thereof initiates a read from code store 126. When the charging device is plugged the battery controller 114 and retrieval circuit may sense the plugging or connection of the charging device 104 to the host device 102 and the power interface 106 obtains power and/or senses current. In a further embodiment, the power interface 106 can sense signal flow at the authentication interface 108 and the connector or port 120 can sense a signal or change in current, frequency or voltage and connector or port 130 can continually send a “Hello” signal (via wires or wirelessly) that is received by retrieval circuit 116. In step 306, code transmittal circuit 128 formats the identifier for transmission over either interface 108 (FIG. 1) or interface 106 (FIG. 2). In step 308, code transmittal circuit 128 transmits the identifier over either interface 106 or 108. In step 310, code retrieval circuit 116 receives the transmission from charging device 104. In step 312, code retrieval circuit 116 decodes the transmission such that battery controller 114 can recognize the identifier and sends the identifier to battery controller. In step 314, battery controller 114 determines whether the identifier meets a predetermined criteria. For example, if the identifier is a code, battery controller 114 compares the code to a code embedded in memory of host device 102. In step 316, the battery controller 114 determines whether the identifier matches the identifier embedded in memory. If the identifier matches the identifier in memory, then, in step 318, battery controller 114 allows charging device 104 to charge battery 110. If the identifier does not match the identifier in memory, then in step 320, charging is disabled, i.e. battery controller 114 prevents the charging device 104 from charging battery 110.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for validating whether a battery charging device is authorized to charge a battery, comprising:
receiving an identifier from the battery charging device;
evaluating whether the identifier meets at least one predetermined criteria;
if the identifier meets the at least one predetermined criteria, allowing the battery charging device to charge the battery.

2. The method of claim 1, wherein the step of receiving comprises:
receiving a code from the battery charging device.

3. The method of claim 2, wherein the step of evaluating comprises:
comparing the code from the battery charging device to a preexisting code.

4. The method of claim 2, wherein the step of allowing the battery charging device to charge the battery comprises:
allowing the battery charging device to charge the battery if code from the battery charging device matches the preexisting code.

5. The method of claim 2, wherein the code is representative of a manufacturer of the battery charging device.

6. The method of claim 2, wherein the code is representative of a manufacturer of the battery.

7. The method of claim 2, wherein the code is representative of a manufacturer of a host device carrying the battery.

8. The method of claim 2, wherein the code is representative of a model no. of a host device carrying the battery.

9. The method of claim 2, wherein the code is representative of a type of a host device carrying the battery.

10. The method of claim 1, further comprising:
preventing the battery charging device from charging the battery if the identifier does not meet the at least one predetermined criteria.

11. The method of claim 1, wherein the step of receiving comprises:
receiving the identifier over a single conductor interface connected to the battery charging device.

12. The method of claim 1, wherein the identifier includes a hand shake signal provided by voltage, frequency, current or power supply variations between the charging device and a host carrying the battery.

13. The method of claim 1, wherein the identifier includes a variable event sequence during a predetermined time period.

14. The method of claim 1, wherein the step of receiving comprises:
receiving the identifier over a multiple conductor interface connected to the battery charging device.

15. The method of claim 14, wherein the step of receiving comprises:
receiving the code over conductors that also carry a charging current from the battery charging device.

16. The method of claim 1, wherein the step of receiving comprises:
receiving the identifier over a wireless interface from the battery charging device.

17. The method of claim 1, wherein the step of receiving comprises:
receiving an encoded signal from the battery charging device; and
extracting the identifier from encoded signal.

18. A system comprising:
a battery charging device, wherein the battery charging device includes circuitry that stores an identification code;
a battery powered host device, wherein the battery powered host device includes a battery, an authorization code store, and battery control circuitry that allows the battery charging device to charge the battery if the identification code matches a preexisting code stored in the authorization code store;
at least one interface that connects the battery powered host device to the battery charging device.

19. The system of claim 18, wherein the circuitry that stores the identification code is a read only memory (ROM).

20. The system of 18, wherein the identification code represents the manufacturer of the battery charging device.

21. The system of 18, wherein the identification code represents the manufacturer of the host device.

22. The system of 18, wherein the identification code represents the type of host device or battery charging device.

23. The system of claim 18, wherein the authorization code store comprises read only memory embedded in the battery control circuitry.

24. The system of claim 18, wherein the charging device includes an authorization code store comprises read only memory embedded in the battery control circuitry.

25. The system of claim 18, wherein the authorization code store comprises read only memory embedded in core circuitry of the host device.

26. The system of claim 18, wherein the authorization code store comprises random access memory, volatile or non-volatile memory embedded in the battery control circuitry.

27. The system of claim 18, wherein the at least one interface comprises:
a power interface that transmits a charging current from the battery charging device to the battery powered host device; and
a data interface that transmits code data between the battery powered host device and the battery charging device.

28. The system of claim 27, wherein the data interface and power interface both share a two conductor interface.

29. The system of claim 27, wherein the data interface is a one conductor interface.

30. The system of claim 27, wherein the data interface is a multiple conductor interface.

31. The system of claim 27, wherein the data interface is a wireless interface.

32. The system of claim 27, wherein the battery control circuitry comprises circuitry for reading data from the authorization control store and extracting the identification code from the data.

33. A battery charger comprising:
an alternating current (AC) or direct current (DC) to direct current (DC) power supply;
an authorization code store that contains an identifier for the battery charger; and
at least one interface to connect the battery charger to a battery powered host device.

34. The battery charger of claim 33, wherein the at least on interface comprises:
a power supply interface to provide a charging current to the battery powered host device; and
a data interface to exchange code data with the battery powered host device.

35. The battery charger of claim 33, wherein the authorization code store comprises a read only memory (ROM).

36. An article for validating whether a battery charging device is authorized to charge a battery comprising:
a computer-readable signal-bearing medium;
logic in the medium to receive an identifier from the battery charging device;
logic in the medium to evaluate whether the identifier meets at least one predetermined criteria;
logic in the medium to allow the battery charging device to charge the battery if the identifier meets the at least one predetermined criteria.

37. The article of claim 36, wherein the logic in the medium to receive an identifier comprises:
logic in the medium to receive a code from the battery charging device.

38. The article of claim 37, wherein the logic in the medium to evaluate comprises:
logic in the medium to compare the code from the battery charging device to a preexisting code.

39. The article of claim 37, wherein the logic in the medium to allow the battery charging device to charge the battery comprises:
logic in the medium to allow the battery charging device to charge the battery if the code from the battery charging device matches the preexisting code.

40. The article of claim 37, wherein the code is representative of a manufacturer of the battery charging device.

41. The article of claim 36, further comprising:
logic in the medium to prevent the battery charging device from charging the battery if the identifier does not meet the at least one predetermined criteria.

42. The article of claim 36, wherein the logic in the medium to receive comprises:
logic in the medium to receive the identifier over a single conductor interface connected to the battery charging device.

43. The article of claim 36, wherein the logic in the medium to receive comprises:
logic in the medium to receive the identifier over a multiple conductor interface connected to the battery charging device.

44. The article of claim 43, wherein the logic in the medium to receive comprises:
logic in the medium to receive the code over conductors that also carry a charging current from the battery charging device.

45. The article of claim 36, wherein the logic in the medium to receive comprises:
logic in the medium to receive the identifier over a wireless interface from the battery charging device.

46. The article of claim 36, wherein the logic in the medium to receive comprises:
logic in the medium to receive an encoded signal from the battery charging device; and
logic in the medium to decode the encoded signal such that the identifier is extracted.
